(19) United States
(12) Patent Application Publication
(10) Pub. No.: US 2025/0284174 A1
(43) Pub. Date: Sep. 11, 2025

(54) Optical Circuit

(71) Applicant: Nippon Telegraph and Telephone Corporation, Tokyo (JP)

(72) Inventors: Yusuke Nasu, Musashino-shi, Tokyo (JP); Yuichiro Ikuma, Musashino-shi, Tokyo (JP); Yosuke Hinakura, Musashino-shi, Tokyo (JP); Shin Kamei, Musashino-shi, Tokyo (JP)

(21) Appl. No.: 18/861,845

(22) PCT Filed: May 10, 2022
(86) PCT No.: PCT/JP2022/019836

§ 371 Date: Oct. 30, 2024

(51) Int. Cl. G02F 1/225; G02F 1/015; G02F 1/21

(52) U.S. Cl. CPC G02F 1/2257; G02F 1/0154; G02F 1/212; G02F 1/218

(57) ABSTRACT

An inspection circuit that accurately reflects influence of a manufacturing error generated in a modulator of a main circuit in manufacturing process of an optical circuit, and at the same time, achieves downsizing, is disclosed. The inspection circuit includes an inspection waveguide having a length of half of a length of an arm waveguide of the main circuit and is configured such that test light propagates in two directions on the inspection waveguide, thereby implementing reproduction of characteristics equivalent to those of the modulator of the main circuit. In order to propagate the test light in two directions of the inspection waveguide in the inspection circuit, a loop-shaped path configured between branch ports of the optical branches is utilized. Embodiments of different configurations are disclosed in accordance with aspects where two branch light beams of the test light are guided to the inspection waveguide.

### TECHNICAL FIELD

The present invention relates to a silicon photonics optical circuit, and more particularly to an inspection circuit of an optical circuit.

### BACKGROUND ART

Along with the progress of optical communication systems, various optical parts constituting the systems are implemented by integrated optical circuits and contribute to downsizing, economy, and capacity enlargement of the systems. In optical circuits, Si photonics using silicon (Si), which is widely used as a semiconductor, as a core material has attracted attention, and research and development have been actively conducted. The Si photonics optical circuit can significantly downsize the circuit as compared with optical circuits in related art. A refractive index of Si is very large, and thus, confinement of light is strong as compared with optical circuits in related art that has been developed based on a low refractive index material, and a waveguide with a small bending radius can be configured. Various circuit elements such as an optical coupler, a multiplexer, a filter, a modulator, and an optical receiver can be downsized and integrated into one chip to implement a very small optical circuit.

The Si photonics optical circuit can implement a desired function such as an optical transceiver by integrating various circuit elements. In order to actually use a Si photonics optical circuit, a Si photonics chip is packaged in an optical module, and an input/output terminal of light or electric signals is configured. By incorporating the optical module into a transmission device, or the like, it is possible to efficiently construct and operate an optical communication system.

In order to manufacture an optical module in which a Si photonics chip is incorporated at low cost, it is important to inspect appropriate characteristics of chip performance in intermediate process before the optical module is completed. In order to ensure a final performance yield of the optical module, it is particularly important to select Si photonics satisfying the performance and modularize only non-defective products.

In a CMOS circuit, or the like, using the same Si and having only an electric circuit, a general-purpose wafer inspection technology can be utilized, so that non-defective products in a wafer state can be easily selected. Compared with inspection of the CMOS circuit, or the like, a Si photonics optical circuit is inspected using both light and electric signals. Thus, the inspection of the Si photonics optical circuit is very complicated, leading to increase in cost in terms of device cost and inspection time as disclosed in Patent Literature 1.

In order to simplify the inspection of the Si photonics chip, there is a method of inspecting only circuit elements constituting the Si photonics optical circuit without inspecting all of the Si photonics optical circuits in the chip. Beside the main circuit, which is the Si photonics optical circuit to be actually used, in the Si photonics chip, circuit elements that are the same as circuit elements to be used in the main circuit are integrated. In order to inspect the main circuit, it is necessary to simultaneously drive light or an electric signal that causes the main circuit to operate. On the other hand, in a case of inspecting only the circuit elements, the number of light beams or electric signals to be driven is significantly reduced. By inspecting only circuit elements instead of the main circuit, estimating characteristics of the entire main circuit and performing pass/fail determination of performance, it is possible to inspect the Si photonics chip at lower cost.

### CITATION LIST

### Patent Literature

Patent Literature 1: JP 2019-96763 A

### SUMMARY OF INVENTION

### Technical Problem

However, providing circuit elements for inspection in addition to the main circuit leads to increase in a chip area. It has not yet been implemented to accurately reproduce an amount of characteristic degradation due to a manufacturing error generated in a modulator that occupies a particularly large area, and to downsize an optical circuit at the same time.

### Solution to Problem

One aspect of the present invention is an optical circuit formed on a silicon substrate, the optical circuit including: a Mach-Zehnder interferometer type modulator including two arm waveguides in which a PN junction is formed in a cross section; and an inspection circuit of the modulator, the inspection circuit including: an input section for receiving test light, the input section including a rectangular waveguide; at least one inspection waveguide being connected to the rectangular waveguide, in parallel to the two arm waveguides, and having a PN junction having the same configuration as the PN junction of at least one of the arm waveguides; and an optical branch for splitting the test light to two branch light beams having equal intensity and propagating the two branch light beams to the inspection waveguide in opposite directions to each other, the optical branch including a rectangular waveguide.

### Advantageous Effects of Invention

An optical circuit of the present invention provides an inspection circuit that accurately reflects a manufacturing error of a main circuit including a modulator and achieves downsizing.

### BRIEF DESCRIPTION OF DRAWINGS

FIG. 1 is a view illustrating a configuration of an optical module including a Si photonics chip.

FIG. 2 is a view illustrating a configuration of a Si photonics chip including an inspection circuit of a modulator.

FIG. 3 is a view illustrating a configuration of a Si photonics chip including another optical circuit of the modulator.

FIG. 4 is a view illustrating a configuration of a general Mach-Zehnder interferometer type modulator.

FIG. 5 is a view illustrating cross-sectional structures of waveguides in two arm waveguides.

FIG. 6 is a view illustrating a configuration of an inspection circuit in related art in an optical circuit including a modulator.

FIG. 7 is a view illustrating a configuration of another inspection circuit in an optical circuit including a modulator.

FIG. 8 is a view illustrating an aspect where a mask is displaced in a zigzag-shaped modulation waveguide.

FIG. 9 is a view illustrating a configuration of an inspection circuit of an optical circuit according to a first embodiment including a modulator.

FIG. 10 is a view illustrating a configuration of an optical branch in the inspection circuit of the first embodiment.

FIG. 11 is a view illustrating a configuration of an inspection circuit of an optical circuit according to a second embodiment including a modulator.

FIG. 12 is a view illustrating a configuration of an inspection circuit of an optical circuit according to a third embodiment including a modulator.

### DESCRIPTION OF EMBODIMENTS

An optical circuit of the present disclosure provides an inspection circuit having a novel configuration that accurately reflects a manufacturing error in an optical circuit including a modulator formed on a silicon substrate. An inspection circuit that accurately reflects influence of a manufacturing error generated in a modulator of a main circuit in manufacturing process of an optical circuit, and at the same time, achieves downsizing, is disclosed. In the following description, first, a configuration of an inspection circuit in a Si photonics chip in related art and problems thereof will be described. Next, a configuration and operation of the inspection circuit in the optical circuit of the present disclosure will be described.

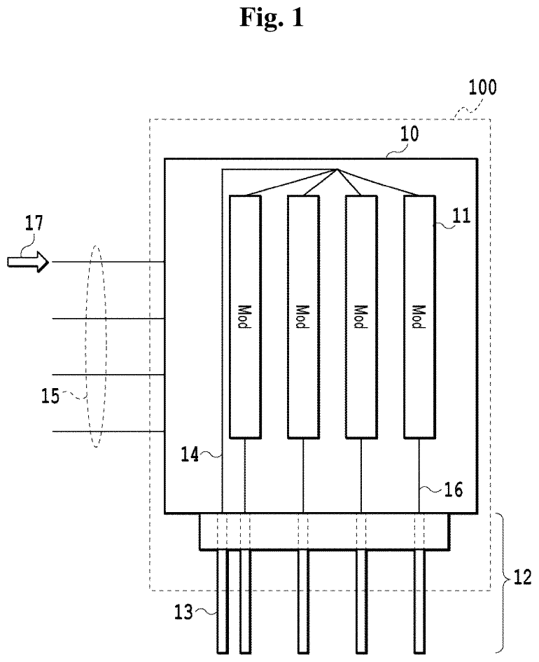

FIG. 1 is a view illustrating a configuration of an optical module including a Si photonics chip. An optical module 100 includes a Si photonics chip 10 including a plurality of optical modulators 11. The Si photonics chip 10 interfaces an electric signal 17 with outside by an electric input/output wiring 15. In addition, the Si photonics chip 10 interfaces light with outside by an optical fiber 13 fixed by an optical fiber assembly 12. The optical circuit in the chip 10 includes four optical modulators 11 connected in parallel to an input waveguide 14 and an output waveguide 16, but the configuration of FIG. 1 is merely an example of the optical circuit. It is assumed that the Si photonics chip 10 described below includes at least one optical modulator 11. In manufacturing process of the optical module 100, it is also possible to easily perform inspection using the electric input/output wiring 15 and an input/output interface of the optical fiber assembly 12.

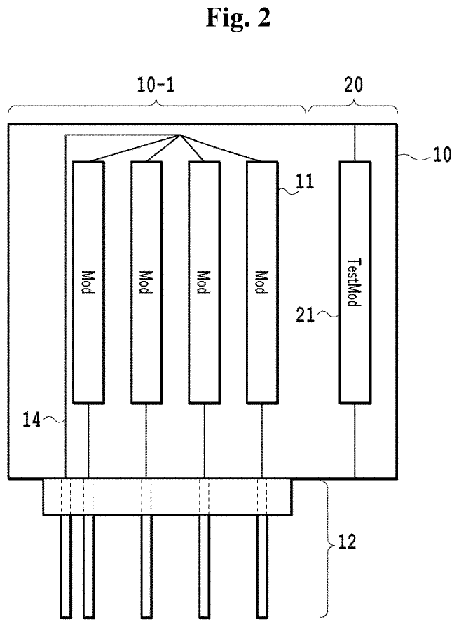

FIG. 2 is a view illustrating a configuration of a Si photonics chip including an inspection circuit of a modulator. In the following description, the Si photonics chip 10 is referred to as a Si chip 10 for simplicity. The Si chip 10 includes the four optical modulators 11 described in FIG. 1 and is a main circuit 10-1 to be actually used after being mounted in the optical module. The Si chip 10 includes an inspection circuit 20 in addition to the four optical modulators (Mod) 11 of the main circuit 10-1.

As described above, it is difficult to inspect the main circuit 10-1 similarly to the configuration as illustrated in FIG. 1 with the Si chip 10 alone before being incorporated into the optical module 100. Thus, by providing an inspection modulator (Test Mod) 21 for a modulator in the Si chip 10 as an inspection circuit and evaluating the inspection modulator 21 instead of the optical modulator 11 of the main circuit 10-1, it is possible to predict performance of the main circuit.

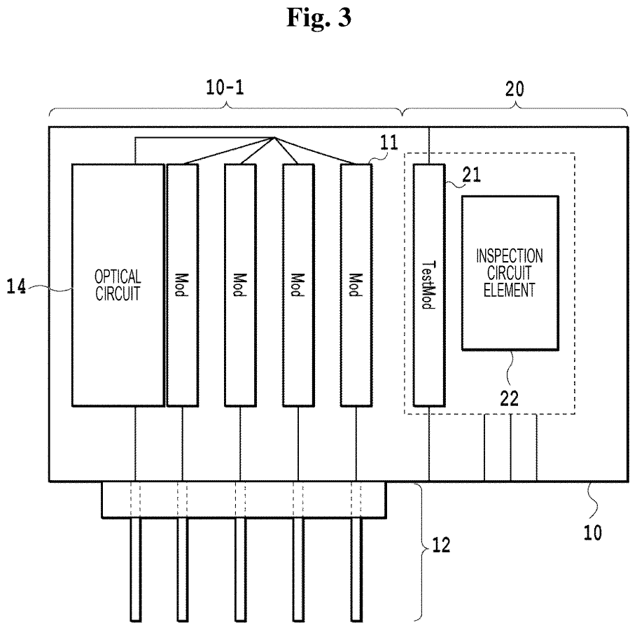

FIG. 3 is a view illustrating a configuration of a Si photonics chip including another optical circuit of the modulator. As illustrated in the main circuit 10-1 of FIG. 3, the Si photonics circuit includes the optical circuit 14 that performs other functions depending on the application and may have a more complicated configuration. Even in such a case, in addition to the inspection modulator 21 of the inspection circuit 20, an element circuit 22 corresponding to the optical circuit 14 used in the main circuit 10-1 can be provided. As illustrated in FIGS. 2 and 3, by evaluating the Test Mod 21 and the element circuit 22 in the inspection circuit 20 and predicting performance of the main circuit 10-1, it is possible to implement practical inspection of a Si chip.

However, providing various circuit elements for inspection in the Si chip in addition to the main circuit 10-1 leads to increase in a chip size. Among the optical circuits used in the Si photonics circuit, the optical modulator 11 occupies a very large area. The Test Mod 21 in the inspection circuit 20 also occupies a large area.

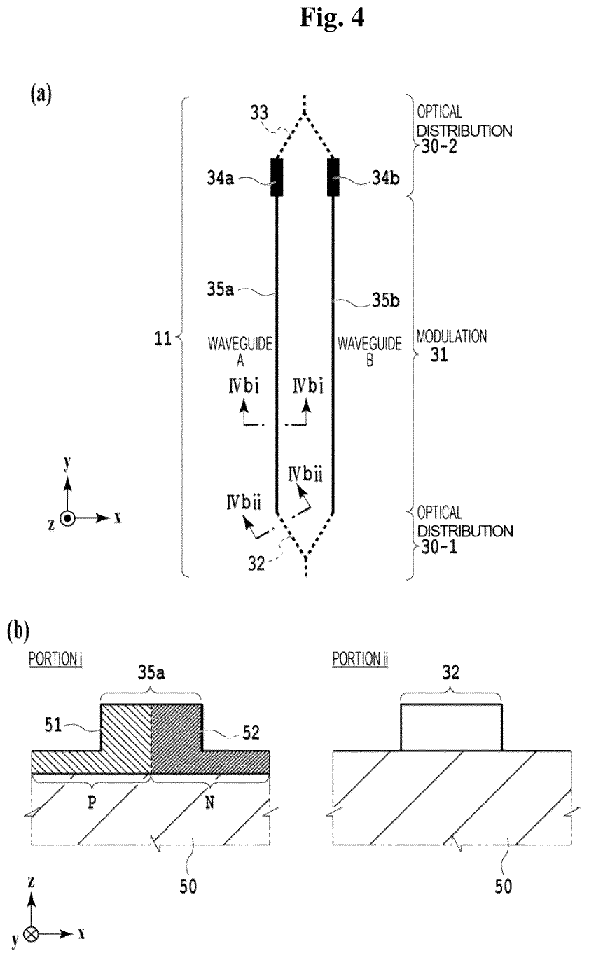

FIG. 4 is a view illustrating a configuration of a general Mach-Zehnder interferometer modulator. FIG. 4 (a) illustrates a top view (x-y plane) of a Mach-Zehnder interferometer (MZI) optical modulator fabricated on a Si substrate, and (FIG. 4 (b) illustrates a cross-sectional view (x-z plane) of a waveguide portion. The optical waveguide MZI type modulator 11 includes two couplers 32 and 33 and two arm waveguides 35a and 35b connecting the couplers. Light input to the coupler 32 on the input side is split, propagated through the two arm waveguides in a y-axis direction and multiplexed by the coupler 33 on the output side. The two couplers 32 and 33 are also referred to as optical distributing portions 30-1 and 30-2 because they have a function of splitting/multiplexing light and distributing light. The arm waveguides 35a and 35b are constituted with modulation waveguides for performing modulation by an electric signal and function as a modulation unit 31. The optical waveguide MZI type modulator 11 is widely used in Si photonics and will be simply referred to as a modulator in the following.

FIG. 4 (b) illustrates a cross section perpendicular to a length direction of each waveguide, and the modulator 11 includes two types of optical waveguides. As the coupler 32 on the input side and the coupler 33 on the output side, for example, a Y branch circuit is used. The optical waveguide has a function of an optical distribution to distribute light from/to the arm waveguide, and generally, a rectangular waveguide is used. A right part of FIG. 4 (b) illustrates, for example, a cross section of a rectangular waveguide of the coupler 32 on the input side, and a ridge-shaped rectangular waveguide (core) 32 is formed on a substrate 50 operating as a cladding. Both the coupler 32 that splits light into two and the coupler 33 that multiplexes two light beams are constituted with rectangular waveguides.

Each of the two arm waveguides 35a and 35b is constituted as a modulation waveguide, and a special form such as a rib-type waveguide is used in order to convert information of an electric signal into an optical signal. A left part of FIG. 4 (b) illustrates a cross section of a rib-type waveguide which is the arm waveguide 35a for modulation. Different impurity doping is performed with the center in an x direction of a rib portion having a step structure as a boundary, and one is a P-type region 51 and the other is an N-type region 52. A refractive index of a core is modulated by applying a reverse bias voltage to the two regions from outside and changing depletion layer capacitance of a PN junction in the vicinity of the boundary. A phase difference of light propagated through the two arm waveguides is changed by refractive index modulation of the core by the electric signal, and an interference state when multiplexed by the coupler 33 is changed according to the electric signal.

The optical modulator 11 includes phase shifters 34a and 34b of rectangular waveguides in addition to the modulation waveguides driven by the electric signal. Desired modulated light can be obtained by adjusting light phase-modulated by the rib-type waveguide of the modulation unit 31 to an appropriate interference state using the phase shifters 34a and 34b.

As illustrated in the cross-sectional view of FIG. 4 (b), the arm waveguide in which modulation is performed by the modulation unit 31 is greatly different from the rectangular waveguides in the couplers 32 and 33 that perform optical distribution in that a PN junction is formed by two doping regions in a cross section of the core.

In the modulator 11 illustrated in FIG. 4 (a), the entire length of the modulator is generally several 100 um to several mm depending on design conditions. Thus, if a modulator having the same structure as that of FIG. 4 (a) is provided in the chip as the inspection circuit, a chip area is greatly increased. In order to inspect an optical loss in the modulator, it is important to accurately reproduce a loss of the modulation waveguide. If manufacturing variation, or the like, as described later occurs and characteristics of the modulator in the main circuit degrade, it is necessary to accurately reproduce the degradation also in the inspection circuit.

In the modulator 11 illustrated in FIG. 4 (a) and (b), the loss of the modulation arm waveguide having a rib-type structure greatly affects characteristics of the modulator. Thus, in the inspection of the modulator, it is important how accurately a loss of the modulation arm waveguide in which the PN junction is formed by the two types of doping regions is evaluated.

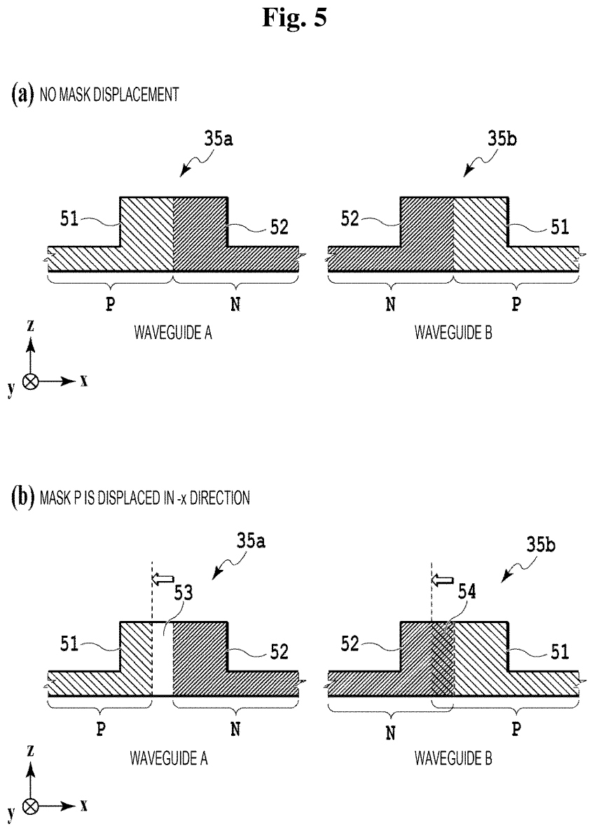

FIG. 5 is a view illustrating cross-sectional structures of waveguides in two arm waveguides. FIG. 5 (a) illustrates a cross-sectional structure in a case where a mask is not displaced, and FIG. 5 (b) illustrates a cross-sectional structure in a case where a mask for generating a P-type region is displaced in the −x direction. As illustrated in FIG. 4 (a), the modulator 11 includes two arm waveguides 35a and 35b, and in the following description, the arm waveguide on the left side in a light propagation direction is referred to as a waveguide A, and the arm waveguide on the right side is referred to as a waveguide B in order to distinguish the two arm waveguides. The arm waveguides 35a and 35b have a rib-type structure in which a silicon portion is stepped to be convex. Impurities are introduced such that a center position of a convex portion of the rib in an x-axis direction becomes a boundary position between the P-type region and the N-type region. For example, impurities are implanted by ion implantation (hereinafter, an implanter).

FIG. 5 (a) illustrates an ideal state in which the PN junction is accurately formed at the center position of the core in a case where a mask for the implantation process is not displaced. In the modulation waveguide having the rib-type structure illustrated in FIG. 5, in the cross-sectional structure (x-z plane) of the waveguide A 35a and the waveguide B 35b, the P-type region 51 and the N-type region 52 are designed symmetrically. When viewed in the top view (x-y plane) in FIG. 4 (a), a PN junction is formed with the center line along a length direction of each of the arm waveguides 35a and 35b as a boundary. Furthermore, the P-type region and the N-type region are arranged symmetrically with respect to the center line of the modulator 11 along a light traveling direction (y direction). In other words, a symmetrical design is used in both a shape of the arm waveguide and arrangement of the two impurity regions. In order to prevent degradation of characteristics due to various manufacturing process variations of the two modulation waveguides of the MZI, it is possible to use the symmetric structure as described above.

While various aspects of degradation of characteristics due to a manufacturing error in rib-type waveguides are conceivable, one of the typical aspects is increase in a loss of the waveguide. One factor of the increase in a loss is displacement of the respective implantation positions for forming the P-type region 51 and the N-type region 52, which occurs independently due to displacement of the respective masks for the P-type region and the N-type region. Another factor of the increase in a loss of the waveguide is displacement of the shape of the waveguide due to a process error of fabricating the convex structure of the rib-type waveguide. In a case where the PN junction is formed symmetrically as in FIG. 5 (a) without the mask being displaced and without the shape of the waveguide being displaced, the same loss is given to light propagating through the two arm waveguides. Thus, the waveguide A and the waveguide B have the same characteristics.

FIG. 5 (b) illustrates a state in which the PN junction is formed while being displaced from the ideal structure in a case where the mask for the implantation process of the P-type region is displaced due to a manufacturing error. Specifically, a case where the mask of the P-type region is displaced in the −x direction is illustrated, and in the waveguide A 35a, a blank region 53 in which no impurity is introduced is formed in the central portion of the core. In addition, in the waveguide B 35b, P-type impurities are introduced in an overlapped manner to the N-type region side beyond the core center, and a substantial impurity concentration decreases in an overlapping region 54. In a case where the mask is displaced as illustrated in FIG. 5 (b), in both the waveguide A 35a and the waveguide B 35b, an impurity doping profile deviates from an ideal state, and an error occurs in the structure and characteristics of the PN junction. Thus, the loss of the waveguide in the two arm waveguides fluctuates, and a fluctuation amount varies for each implantation process. In the main circuit of the optical circuit including the modulator, in a case where degradation of characteristics occurs due to a manufacturing error as described above, it is required that the degradation of the characteristics can be accurately detected in the inspection circuit.

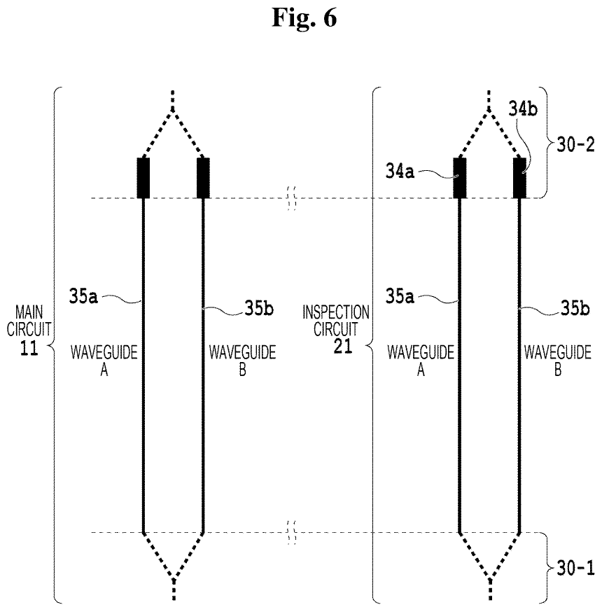

FIG. 6 is a view illustrating a configuration of an inspection circuit in related art in an optical circuit including a modulator. Part of a substrate (chip) of a Si photonics circuit is illustrated, and an MZI type modulator 11 in the main circuit and an MZI type modulator 21 of the inspection circuit are illustrated. For the waveguide A 35a and the waveguide B 35b used for the modulator 11 of the main circuit, the waveguide A 35a and the waveguide B 35b having the same length and the same PN junction structure are arranged in the chip as the modulator 21 of the inspection circuit. Preferably, the two arm waveguides of the main circuit and the two arm waveguides of the inspection circuit are arranged so as to be completely parallel, and positions in the waveguide length direction are the same. The modulator 11 of the main circuit and the modulator 21 of the inspection circuit have the same design, and thus, influence of displacement of an implantation position and a manufacturing error of a convex structure generated in the manufacturing process on characteristics of the modulator is also the same between the main circuit and the inspection circuit. By inspecting the waveguide A and the waveguide B of the modulator 21 of the inspection circuit through rectangular waveguides of optical distributing portions 30-1 and 30-2, performance of the modulator 11 of the main circuit can be estimated.

As described above, in the configuration illustrated in FIG. 6, the modulator 11 of the main circuit and the modulator 21 of the inspection circuit have the same size, and thus, increase in a chip area becomes a problem. Furthermore, an interference state needs to be adjusted by the phase shifters 34a and 34b, which requires a complicated inspection system using light and an electric signal. Although not clearly illustrated in FIG. 6, the rectangular waveguides of the optical distributing portions 30-1 and 30-2 of the inspection circuit 21 extend to an end surface of the Si chip and are connected to an optical fiber, or the like, via a substrate end surface, and a loss is inspected. It is necessary to connect the circuit to the optical measurement system by two fibers.

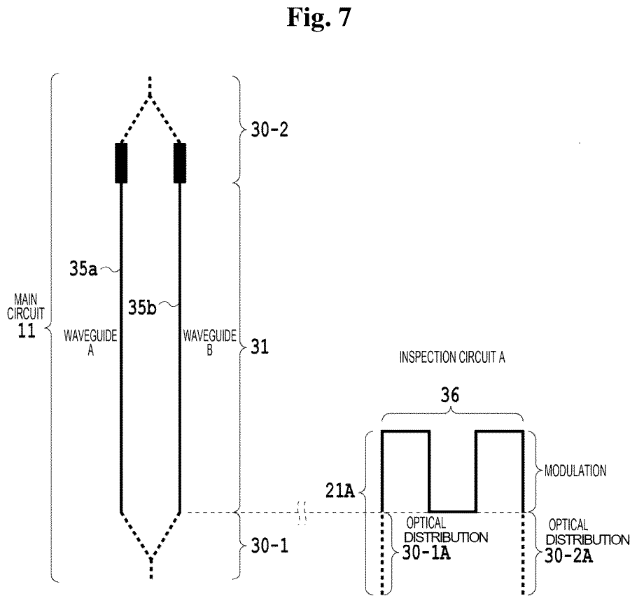

FIG. 7 is a view illustrating a configuration of another inspection circuit in an optical circuit including a modulator. Unlike the modulator 21 of the inspection circuit illustrated in FIG. 6, an inspection circuit 21A in a right part of FIG. 7 does not have a form of a modulator, but is an inspection circuit that estimates performance of the waveguide A 35a of the main circuit. The inspection circuit is downsized by the modulation waveguide 36 having the same length as the length of the modulation waveguide A 35a of the main circuit and having a zigzag folded shape. Rectangular waveguides of optical distributing portions 30-1A and 30-2A have the same length as the optical distributing portions 30-1 and 30-2 of the main circuit. In such an inspection circuit, a manufacturing error of a rib shape (convex structure) in the manufacturing process is the same between the main circuit and the inspection circuit, and it seems that the same inspection accuracy as that of the inspection modulator 21 in FIG. 6 can be obtained. However, an implantation positional displacement amount and a displacement aspect when the mask is displaced in either the P-type region or the N-type region are greatly different between the modulator 11 of the main circuit and the inspection circuit 21A as described below.

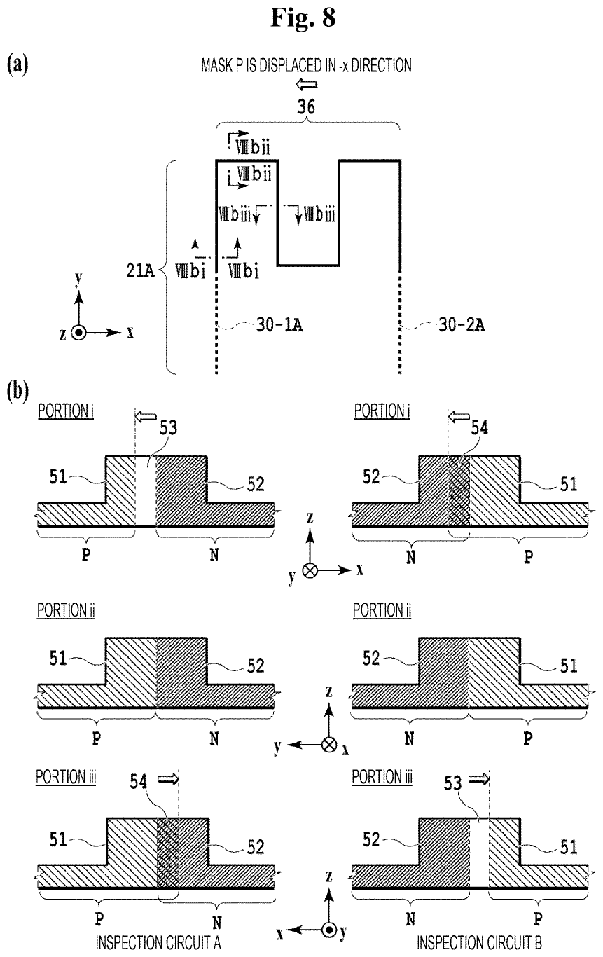

FIG. 8 is a view illustrating an aspect where the mask is displaced in the zigzag-shaped modulation waveguide. FIG. 8 (a) is the same as the inspection circuit 21A illustrated in FIG. 7 and illustrates three portions of the modulation waveguide 36 through which light propagates. Light input to the optical distributing portion 30-1A including the rectangular waveguide first propagates through a portion i of the modulation waveguide 36 in the +y direction. The light then propagates through a portion ii in the +x direction and subsequently further propagates through a portion iii in the −y direction. In the modulation waveguide 36, light changes its direction in a zigzag manner and propagates while sensing the waveguide structure. Thus, whether or not the waveguide structure of the inspection circuit sensed by the light along the propagation direction accurately reflects a state of the main circuit becomes a problem in estimating performance in the main circuit.

FIG. 8 (b) illustrates waveguide structures that light senses in the modulation waveguide 36 having a zigzag folded shape in a case where the mask for the P-type region is displaced in the −x direction. A left part illustrates cross-sectional structures of the waveguide in the order of the portion i, the portion ii, and the portion iii along the propagation direction for the modulation waveguide 36 of FIG. 8 (a) corresponding to the waveguide A. In other words, it should be noted that each drawing of FIG. 8 (b) illustrates a waveguide structure that light senses as light propagates. The right part of FIG. 8 (b) illustrates cross-sectional structures of a modulation waveguide (not illustrated) having the same shape as the modulation waveguide 36 of FIG. 8 (a) and corresponding to the waveguide B 35b of the main circuit, in the order of the portion i, the portion ii, and the portion iii along the propagation direction. Although the modulation waveguide for the waveguide B is not illustrated, it is only necessary to horizontally invert the entire shape of the modulation waveguide 21A in FIG. 8 (a) and also invert the P-type region and the N-type region.

In the portion i where light propagates in the y direction in an upper left part of FIG. 8 (b), only the P-type region is displaced in the −x direction, so that the blank region 53 into which no impurity is introduced is generated. If it is assumed that neither the mask for the P-type region nor the mask for the N-type region is displaced in the y direction in the portion ii where the light propagates in the x direction in the left middle part of FIG. 8 (b), an ideal PN junction state is obtained. Furthermore, in the portion iii where light propagates in the −y direction in a lower left part of FIG. 8 (b), only the P-type region is displaced in the −x direction, and thus, the overlapping region 54 where P-type impurities overlap on the N-type region side beyond the core center is generated.

It should be noted in FIG. 8 (b) that when the cross-sectional structure of the zigzag-shaped modulation waveguide 36 is viewed along the light propagation direction, the shape of the PN junction generated by the mask displacement varies depending on the light propagation direction. In other words, the cross-sectional structure of the waveguide that light senses changes according to the direction in which light propagates. In the waveguide A 35a of the main circuit illustrated in FIG. 7, in a case where the mask for the P-type region is displaced in the −x direction similarly to the case of FIG. 8, the cross section of an entire length has the structure of the portion i illustrated in the upper left part of FIG. 8 (b). Thus, the inspection circuit 21A using the modulation waveguide 36 folded in a zigzag shape as illustrated in FIG. 8 (a) does not accurately represent the aspect of the mask displacement generated in the waveguide A 35a of the main circuit. The inspection circuit 21A folded in a zigzag shape does not correctly reflect the influence caused by a manufacturing error of the modulation waveguide in the main circuit, and accuracy of the optical circuit as the inspection circuit degrades.

In the example of FIG. 8, it is assumed that neither the mask for the P-type region nor the mask for the N-type region is displaced in the y direction, but if the mask is displaced in the y direction, the cross section of the portion ii in the left middle part of FIG. 8 (b) also changes. In the waveguide A 35a of the main circuit, the y direction is the length direction of the waveguide, and thus, even if the mask is displaced in the y direction, no problem occurs in the waveguide cross-sectional structure. However, in the inspection circuit 21A using the modulation waveguide folded in a zigzag shape, even a change in the waveguide structure that cannot originally occur will occur. Further, the mask for the P-type region and the mask for the N-type region are displaced independently in the P-type region and the N-type region. Change in performance of the modulation waveguide caused by the mask displacement is different between the main circuit and the inspection circuit. Although not clearly illustrated in FIG. 7 also from the viewpoint of the measurement system, the rectangular waveguides of the optical distributing portions 30-1A and 30-2A of the inspection circuit 21 extend to the end surface of the Si chip, are connected to an optical fiber, or the like, via the substrate end surface, and a loss is inspected. It is necessary to optically connect the circuit to two fibers at end surfaces of two sides of the chip, which face each other.

The inspection circuit 21 illustrated in FIG. 6 is not sufficient in that a chip size is increased, and the inspection circuit 21A illustrated in FIG. 7 is not sufficient in that the inspection circuit 21A cannot accurately reflect fluctuation of the characteristics of the modulation waveguide of the main circuit and cannot detect degradation of the characteristics due to a manufacturing error. In an optical circuit including a modulator, there is a demand for an inspection circuit that accurately reproduces a fluctuation amount of the characteristics due to a manufacturing error generated in the modulator of the circuit and simultaneously achieves downsizing.

In the optical circuit of the present disclosure, an inspection circuit that accurately reflects influence of a manufacturing error generated in the optical modulator of the main circuit and achieves downsizing is presented. In a novel inspection circuit described below, an inspection method using only test light without using an electric signal is adopted, and inspection process of an MZI type modulator is simplified. First, the principle of detecting change of the characteristics of the MZI type modulator due to influence of a manufacturing error only by a loss of the arm waveguide in a state where no electric signal is applied will be described.

In general, a modulator has an electric terminal that controls a phase difference. The phase difference is adjusted such that a loss of the entire modulator is minimized by a control voltage to be applied to the electric terminal. Inspection of a loss is performed by making light incident on the modulator in a state where the control voltage is applied. In an optical circuit including a modulator, an inspection system and procedure of inspection using electricity and light are complicated. In order to simplify the inspection process, an inspection method using only light for inspection is important.

In a case where the modulator is implemented by the MZI type configuration including the two arm waveguides as illustrated in FIG. 4, the waveguide A 35a and the waveguide B 35b are ideally designed so as to have equal transmittance. However, in a case where the implantation position is displaced or a process error in fabrication of the convex structure of the waveguide occurs, a difference occurs in the transmittance between the waveguide A and the waveguide B. In consideration of such a situation, if electric field transmittance of the waveguide A is set at t_{A}, electric field transmittance of the waveguide B is set at t_{B}, and a phase difference between the arm waveguides is set at ϕ, transmittance TM of the MZI can be expressed by the following expression.

$$\begin{matrix}[ Math . 1 ] & \\ {T}_{M} = \frac{1}{4} ( {t}_{A}^{2} + {t}_{B}^{2} + 2 * {t}_{A} * {t}_{B} * cos φ ) & Expression ( 1 )\end{matrix}$$

The above expression represents the principle of amplitude modulation by the MZI type modulator, and the entire transmittance is modulated by controlling the phase difference ϕ by an electric signal, thereby the modulator can be used as an optical modulator. In a case where the phase difference ϕ (cosϕ=1) in a case where the MZI type modulator transmits light most (loss is minimum) is given to the modulator, the transmittance T_{M} of Expression (1) becomes as follows.

$$\begin{matrix}[ Math . 2 ] & \\ {T}_{M} = \frac{1}{4} {( {t}_{A} + {t}_{B} )}^{2} {( \frac{{t}_{A}}{2} + \frac{{t}_{B}}{2} )}^{2} & Expression ( 2 )\end{matrix}$$

As indicated in Expression (2), if the transmittances t_{A} and t_{B} of the waveguide A and the waveguide B can be individually obtained, the total transmittance T_{M} as the modulator can be estimated. Thus, if the transmittances t_{A} and t_{B} of the waveguide A and the waveguide B can be measured by an accurate inspection circuit, the influence of a manufacturing error can be accurately grasped and reflected in quality evaluation of the manufacturing process.

In the optical circuit of the present disclosure, in order to implement reproduction of the same characteristics as those of the modulator of the main circuit with a more downsized inspection circuit, the inspection waveguide having a length of half of a length of the arm waveguide of the main circuit is provided, and test light is configured to propagate in two directions on the inspection waveguide, thereby implementing reproduction of characteristics equivalent to those of the modulator of the main circuit. In order to propagate the test light in two directions of the inspection waveguide in the inspection circuit, a loop-shaped path configured between branch ports of the optical branches is utilized. Embodiments of different configurations are disclosed in accordance with aspects where two branch light beams of the test light are guided to the inspection waveguide. The optical branch splits the test beam to equal intensity and multiplexes the two branch light beams in the same phase after the branch light beams propagate through the loop-shaped path. By dividing the inspection waveguide into a plurality of portions, the length of the inspection waveguide can be further shortened. Further, the length of the inspection waveguide is shortened by a predetermined ratio (1/N) with respect to the arm waveguide of the main circuit, and a loss of the waveguide measured by the inspection circuit is corrected (N/2 times) according to the ratio, so that substantially the same loss estimation of the modulator can be performed.

The configuration of the inspection circuit in the optical circuit of the present disclosure enables accurate estimation of characteristics of the modulator in the main circuit from the characteristics of the inspection waveguide.

### First Embodiment

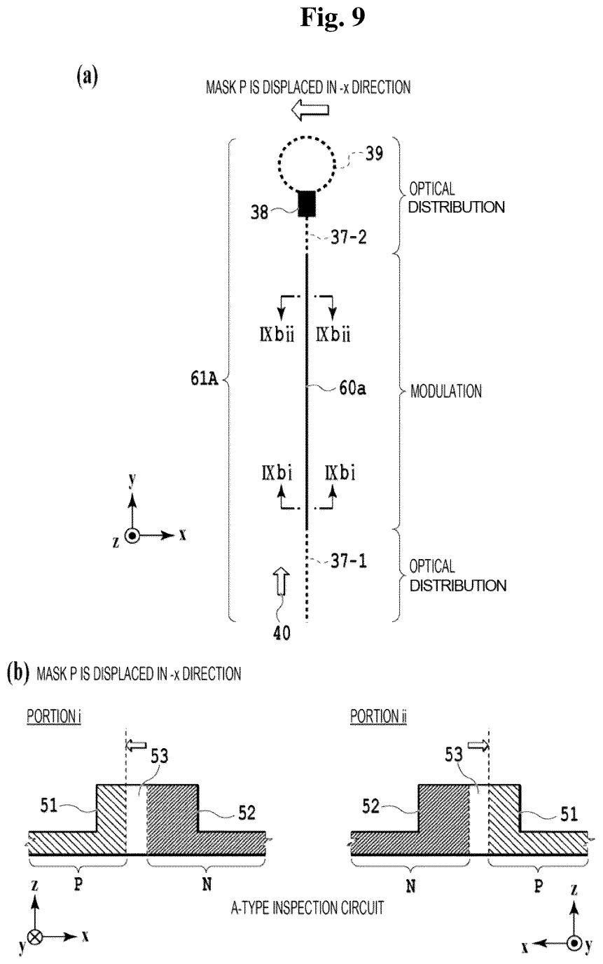

FIG. 9 is a view illustrating a configuration of an inspection circuit in an optical circuit of a first embodiment including the modulator of the present disclosure. FIG. 9 (a) illustrates an upper surface (x-y plane) of an inspection circuit 61A formed on the Si substrate of the optical circuit including the modulator. As illustrated in FIG. 3, the optical circuit includes the main circuit 10-1 and the inspection circuit 20, and the inspection circuit 61A corresponds to the Test Mod 21 that is part of the inspection circuit 20. FIG. 9 (b) illustrates a waveguide cross section (x-z plane) of the inspection waveguide 60a corresponding to the modulation arm waveguide 35a of the main circuit.

Referring to FIG. 9 (a), the inspection circuit 61A includes a rectangular waveguide 37-1 (input section) to which the test light 40 is input, an inspection waveguide 60a connected to the rectangular waveguide 37-1, and a light reflection section that reflects the test light propagated in the +y direction through the inspection waveguide 60 in a reverse direction (−y direction). The light reflection section includes a rectangular waveguide 37-2, an optical branch 38, and a loop-shaped rectangular waveguide 39. If the test light is input to the rectangular waveguide 37-1, the test light propagates in the y direction through the inspection waveguide 60a as it is and is totally reflected by the light reflection section. The totally reflected test light is propagated in the −y direction that is the reverse direction through the inspection waveguide 60a and reaches the rectangular waveguide 37-1. If an end portion of the rectangular waveguide 37-1 is a cut surface of the chip, it can be connected to outside by an optical fiber. A portion fabricated with the rectangular waveguide can be associated with the optical distributing portion of the main circuit.

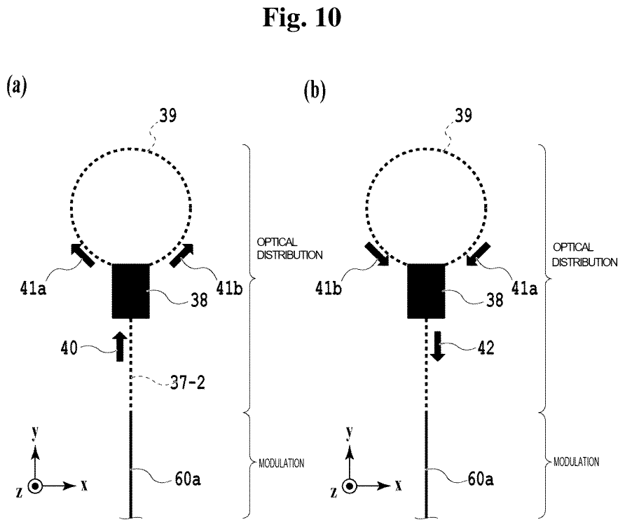

FIG. 10 is a view illustrating a configuration of the light reflection section in the inspection circuit of the first embodiment. FIG. 10 (a) illustrates propagation of the test light in an outward path, and FIG. 10 (b) illustrates propagation of the test light in a return path. In FIG. 10 (a), the test light 40 propagates in the y direction from the inspection waveguide 60a and reaches the optical branch 38. The optical branch equally splits input light and outputs branch light beams 41a and 41b having the same intensity in two directions of the loop-shaped rectangular waveguide 39. In FIG. 10 (b), the branch light beams 41a and 41b propagated around the loop-shaped rectangular waveguide 39 are multiplexed by the optical branch 38 in the same phase and propagated in the inspection waveguide 60a in the reverse direction (−y direction) as the multiplexed test light 42. As described above, the optical branch 38 of the light reflection section operates to split the test light propagated in the outward path of the inspection waveguide to equal intensity and further multiplex the branch light again to propagate the multiplexed light to the inspection waveguide that is the return path. The light reflection section illustrated in FIG. 10 propagates the test light in two directions on the inspection waveguide 60a and operates as a loop back mirror for reciprocating the test light.

Referring again to FIG. 9 (b), cross-sectional structures of the waveguides that the test light senses in the outward path and in the return path in the inspection waveguide 60a are illustrated. A left part of FIG. 9 (b) illustrates a case where the mask for the P-type region is displaced in the −x direction in the waveguide structure of the portion i sensed by the test light traveling in the outward path of the inspection waveguide 60a in the y direction. In other words, only the P-type region 51 is displaced in the −x direction, and thus, the blank region 53 into which no impurity is introduced is generated. A right part of FIG. 9 (b) illustrates a case where the mask for the P-type region is displaced in the −x direction in the waveguide structure of the portion ii sensed by the test light traveling on the return path of the inspection waveguide 60a in the −y direction. It should be noted that the waveguide structures sensed by the test light in the outward path and in the return path are different only in that positions of the P-type region and the N-type region are reversed left and right, and profiles of the PN junctions generated by the mask displacement are substantially the same. The outward path and the return path of the physically identical inspection waveguide 60a are used, and thus, the test light senses a symmetrical cross-sectional structure with respect to the center line of the rib structure. The waveguide structures of the portion i in the outward path and the portion ii in the return path sensed by the test light are the same in that only the P-type region is separated from the center line of the rib structure to form the blank region 53. Thus, in the outward path and in the return path, a loss of the waveguide caused by the mask displacement for the P-type region is also the same. Consistency of the cross-sectional structures sensed by the test light through the outward path and the return path is the same even if displacement occurs only in the mask of the N-type region or displacement occurs simultaneously and independently in both the P-type and N-type masks.

If the length of the inspection waveguide 60a in the inspection circuit 61A is set to half (½) of the length of the arm waveguide 35a which is the modulation waveguide of the main circuit, change in the cross-sectional structure due to the mask displacement, or the like, occurring in the arm waveguide 35a of the main circuit can be accurately reproduced also in the inspection waveguide 60a. This is because the test light propagates substantially the same length as the arm waveguide 35a of the main circuit through the outward path and the return path of the inspection waveguide 60a. Thus, the inspection circuit 61A can accurately reflect influence of a manufacturing error generated in the optical modulator of the main circuit in the manufacturing process. In order to make the aspect of the mask displacement the same, the arm waveguide 35a of the main circuit and the inspection waveguide 60a of the inspection circuit 61A need to be constituted in parallel. Note that the length of the inspection waveguide 60a is not necessarily limited to half (½) of the length of the arm waveguide 35a, which will be finally described.

Thus, the present invention can be implemented as an optical circuit formed on a silicon substrate including: a Mach-Zehnder interferometer type modulator including two arm waveguides 35a and 35b in which a PN junction is formed in a cross section; and an inspection circuit 61A of the modulator, the inspection circuit 61A including: an input section for receiving test light 40 and which including a rectangular waveguide 37-1, at least one inspection waveguide 60a being connected to the rectangular waveguide, in parallel to the two arm waveguides, and having a PN junction having the same configuration as the PN junction of at least one of the arm waveguides 35a, and an optical branch 38 for splitting the test light to two branch light beams having equal intensity and propagating the two branch light beams to the inspection waveguide in opposite directions to each other, the optical branch including a rectangular waveguide. A total length of the at least one inspection waveguide may be ½ of the length of the arm waveguide.

Specifically, the input section is a single rectangular waveguide 37-1, and at least one inspection waveguide comprises a single inspection waveguide 60a that is ½ of the length of the arm waveguide, where one end of the single inspection waveguide is connected to the single rectangular waveguide of the input section, the other end of the single inspection waveguide is connected to an input-side port of the optical branch 38, and a branch-side port of the optical branch is connected in a loop shape by the single rectangular waveguide 39.

The inspection circuit 61A illustrated in FIG. 9 is an inspection circuit for the waveguide A 35a of the main circuit illustrated in FIG. 4. In the inspection circuit 61A, if the positions of the P-type region and the N-type region of the inspection waveguide 60a are reversed, the inspection circuit 61B for the waveguide B 35b of the main circuit is obtained. The transmittance (t_{A}, t_{B}) of each arm waveguide can be inspected by two inspection circuits corresponding to the two arm waveguides of the main circuit. In the inspection circuit 61A of FIG. 9, the inspection can be performed by using only test light without using an electric signal, which only requires a simplified measurement system including only one optical input/output fiber, so that the inspection procedure becomes simpler. The inspection system is greatly simplified as compared with a case where two fibers for measurement are required on two end surfaces of the chip in the inspection circuit 21 in related art. The transmittance of the outward path and the return path of the inspection waveguide 60a having a length that is half of the length of the modulation waveguide 35a of the main circuit coincides with the electric field transmittance of the modulation waveguide 35a of the main circuit. Thus, a loss of the MZI type modulator of the main circuit can be estimated only by substituting the electric field transmittance (t_{A}, t_{B}) obtained from the inspection circuit of the waveguide A and the inspection circuit of the waveguide B into the Expression (2).

In the inspection circuit 61A, a certain degree of an excessive loss occurs in the rectangular waveguide 37-1 serving as a light input/output section and a loop back mirror of the light reflection section. It is therefore necessary to separately obtain an excessive loss by the inspection circuit, or the like, provided for the light reflection section to compensate for the electric field transmittance of the inspection circuit. The arm waveguides 35a and 35b of the main circuit and the inspection waveguide 60a for the waveguide A and the inspection waveguide 60b for the waveguide B of the inspection circuit are designed to be parallel to each other so that there is no difference in the cross-sectional structure of the modulation waveguide between the inspection circuit and the main circuit. As a result, even if displacement of the implantation positions, or the like, occurs, the characteristic fluctuation of the modulator of the main circuit can be accurately estimated in the inspection circuit.

Depending on the design of the modulator, the implantation position, or the like, may be changed in a longitudinal direction in each of the waveguide A and the waveguide B. Even in this case, the characteristics of the main circuit can be estimated from the inspection circuit as illustrated in FIG. 9 by making the length half while maintaining the design in the longitudinal direction.

In the example of FIG. 9, the PN junctions of the two arm waveguides of the main circuit are configured symmetrically with respect to the center line along the light propagation direction of the modulator. The configuration of the PN junction in a cross-section of a first arm waveguide (waveguide A) and the configuration of the PN junction in a cross-section of a second arm waveguide (waveguide B) are symmetric with respect to the center line of the two arm waveguides parallel to the light propagation direction. In this event, a first inspection circuit 61A corresponding to the first arm waveguide and a second inspection circuit 62B corresponding to the second arm waveguide are provided. It should be noted that if the waveguide A and the waveguide B do not have a symmetric structure and have the same structure, a single common inspection circuit is sufficient.

### Second Embodiment

In the inspection circuit 61A in the optical circuit of the first embodiment, the light reflection section including the optical branch is provided at one end of the single inspection waveguide 60a, and the outward path and the return path for the test light are implemented for the single inspection waveguide 60a. The branch-side port of the optical branch is connected in a loop shape by the single rectangular waveguide 39, and thus, the test light (that is, the two branch light beams) propagates through the return path of the inspection waveguide 60a after the two branch light beams are multiplexed. The inspection circuit can be implemented by another configuration of the optical branch that causes the two branch light beams to propagate in opposite directions to each other to the inspection waveguide.

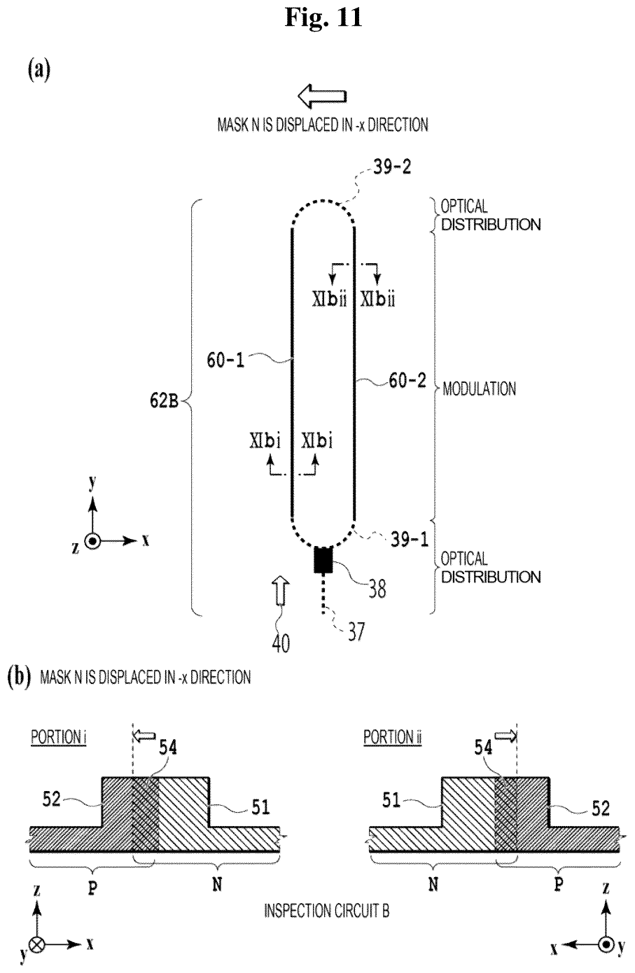

FIG. 11 is a view illustrating a configuration of the inspection circuit in the optical circuit of the second embodiment including the modulator of the present disclosure. FIG. 11 (a) illustrates an upper surface (x-y plane) of the inspection circuit 62B formed on the Si substrate of the optical circuit including the modulator. As illustrated in FIG. 3, the optical circuit includes the main circuit 10-1 and the inspection circuit 10-2, and the inspection circuit 62B in FIG. 11 corresponds to the Test Mod 21 that is part of the inspection circuit 20 in FIG. 3. FIG. 11 (b) illustrates cross-sectional structures (x-z plane) of the portion i of the inspection waveguide 60-1 and the portion ii of the inspection waveguide 60-2 in the two inspection waveguides, which correspond to the arm waveguide 35b (waveguide B) of the main circuit.

Referring to FIG. 11 (a), the inspection circuit 62B has a configuration in which two inspection waveguides 60-1 and 60-2 are included in the loop path of the light reflection section illustrated in FIG. 10. The length of each of the two inspection waveguides 60-1 and 60-2 in the inspection circuit 62B is half (½) of the length of the arm waveguide 35b which is the modulation waveguide of the main circuit. The two inspection waveguides 60-1 and 60-2 have the same cross-sectional structure in terms of a PN junction structure. Thus, in the cross section of the x-z plane, the positional relationship between the P-type region and the N-type region is the same.

The test light 40 is input from a bottommost rectangular waveguide 37 to an input port of the optical branch 38. The test light is equally split by the optical branch 38, and the branch light having the same intensity is output from the branch port in two directions of the loop path including the two inspection waveguides.

One branch light beam output from one branch port of the optical branch 38 propagates in the y direction through the inspection waveguide 60-1, passes through the rectangular waveguide 39-2 and further propagates in the reverse direction (−y direction) through the inspection waveguide 60-2. The one branch light beam propagates clockwise through the loop path and reaches the other branch port. The other branch light beam output from the other branch port of the optical branch 38 propagates counterclockwise through the loop path and reaches the branch port. The two branch light beams propagating in the opposite directions to each other pass through the two inspection waveguides 60-1 and 60-2, respectively, and are lost over the entire lengths of the inspection waveguides 60-1 and 60-2. In the optical branch 38, the two branch light beams propagated through the loop path are multiplexed in the same phase and output from the rectangular waveguide 37 as test light beams having passed through the inspection waveguides 60-1 and 60-2.

Referring now to FIG. 11 (b), the cross-sectional structures of the waveguides sensed by the test light in the above-described two inspection waveguides 60-1 and 60-2 are illustrated. A left part of FIG. 11 (b) illustrates a case where the mask for the N-type region is displaced in the −x direction in the waveguide structure of the portion i sensed by the test light traveling through the inspection waveguide 60-1 in the y direction. In other words, only the N-type region 51 is displaced in the −x direction, and thus, N-type impurities are redundantly introduced on the P-type region side, and the overlapping region 54 is generated. A right part of FIG. 11 (b) illustrates a case where the mask for the N-type region is displaced in the −x direction in the waveguide structure of the portion ii sensed by the test light traveling in the inspection waveguide 60-2 in the −y direction.

Here, the waveguide structures sensed by the test light in the two inspection waveguides 60-1 and 60-2 are different only in that the positions of the P-type region and the N-type region are reversed left and right, and the profiles of the PN junctions caused by the mask displacement are substantially the same. The test light surrounding the loop path will sense a symmetrical cross-sectional structure with respect to the center line of the rib structure. The waveguide structures of the portion i and the portion ii sensed by the test light are the same in that the overlapping region 54 with the P-type region is formed beyond the center line of the rib structure only in the N-type region. Thus, in the two inspection waveguides 60-1 and 60-2, a loss of the waveguide caused by the mask displacement for the N-type region is also the same. Consistency of the cross-sectional structure sensed by the test light through the two inspection waveguides 60-1 and 60-2 is the same even if displacement occurs only in the mask of the P-type region or displacement occurs independently in both the P-type and N-type masks at the same time.

Thus, in the optical circuit of the present embodiment, it can be implemented that the input section is a single rectangular waveguide 37 connected to the optical branch 38, the at least one inspection waveguide comprises two inspection waveguides 60-1 and 60-2 having a ½ length of the length of the arm waveguide, one end of each of the two inspection waveguides is connected to a branch-side port of the optical branch, the other end of each of the two inspection waveguides is connected by the rectangular waveguide 39-2, and the two inspection waveguides are connected in a loop shape between the branch-side ports.

Also in the inspection circuit of the present embodiment, the optical branch 38 operates to propagate the two test light beams split to equal intensity to the inspection waveguide. In the first embodiment, the optical branch 38 multiplexes the two branch light beams and then propagates the multiplexed light beam to the return path of the single inspection waveguide. On the other hand, in the second embodiment, the optical branch 38 propagates the two branch light beams in opposite directions to each other to the inspection waveguide in the loop path. The difference between the first embodiment and the second embodiment depends on whether the inspection waveguide is outside the loop path or included in the loop path. In the first embodiment in which the light reflection section including the loop path by the optical branch is provided at the end of the inspection waveguide, the test light reciprocates in a single inspection waveguide, so that the test light propagates in two directions of the inspection waveguide at different timings. On the other hand, in a case of the second embodiment in which two inspection waveguides are included inside the loop path by the optical branch, it should be noted that the test light propagates simultaneously in two directions on the inspection waveguides.

Total transmittance of the two inspection waveguides 60-1 and 60-2 in the inspection circuit 62B of the present embodiment coincides with the transmittance of the arm waveguide 35b of the main circuit. The transmittance (t_{A}, t_{B}) of each arm waveguide can be inspected by two inspection circuits corresponding to the two arm waveguides of the main circuit. Similarly to the first embodiment, a loss of the MZI type modulator of the main circuit can be estimated only by substituting the electric field transmittance (t_{A}, t_{B}) obtained from the inspection circuit of the waveguide A and the inspection circuit of the waveguide B into the Expression (2). Also in the present embodiment, the arm waveguides 35a and 35b of the main circuit and the two inspection waveguides 60-1 and 60-2 of the inspection circuit are designed to be all parallel to each other so that there is no difference in the cross-sectional structure of the modulation waveguide between the inspection circuit 62B and the main circuit. Also in the inspection circuit 62B of FIG. 11, the inspection can be performed by using only test light without using an electric signal, which only requires a simplified measurement system including only one optical input/output fiber, so that the inspection procedure becomes simpler.

The point that the lengths of the above-described two inspection waveguides 60-1 and 60-2 are not necessarily limited to half (½) of the length of the arm waveguide 35a will be finally described.

### Third Embodiment

In the present embodiment, a configuration example of an inspection circuit in which the length of one inspection waveguide is further shortened by further providing a large number of divided inspection waveguides in the loop path of the optical branch will be described. In the present embodiment, while the total length of the inspection waveguide of the inspection circuit is maintained at half the length of the arm waveguide of the main circuit, the inspection waveguide is divided into a plurality of portions. Unlike the zigzag-shaped inspection circuit in related art illustrated in FIG. 7, influence of a manufacturing error occurring in the optical modulator of the main circuit is accurately reflected, and at the same time, downsizing of the inspection circuit is achieved.

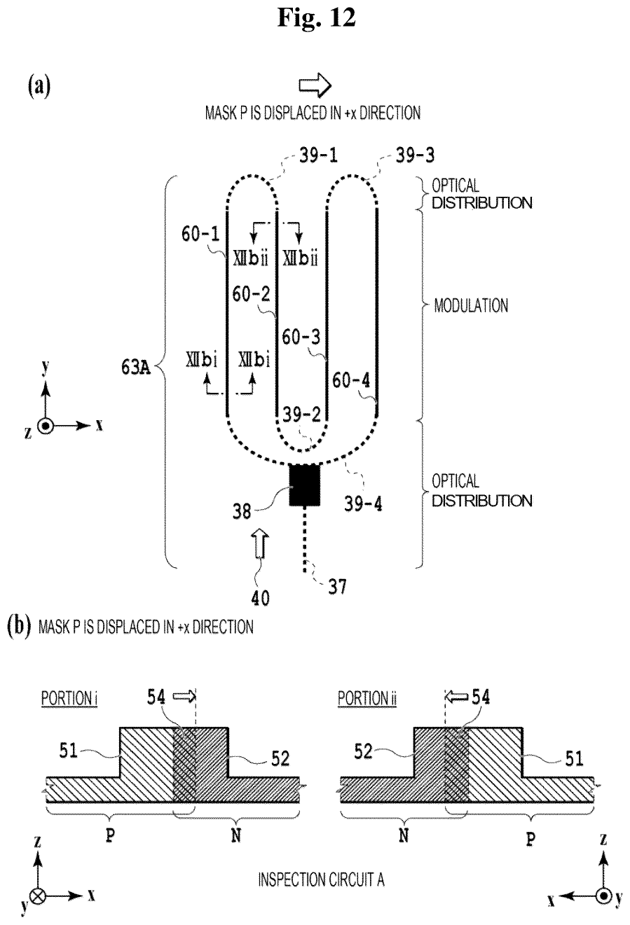

FIG. 12 is a view illustrating a configuration of an inspection circuit of an optical circuit according to the third embodiment including the modulator of the present disclosure. FIG. 12 (a) illustrates an upper surface (x-y plane) of an inspection circuit 63A formed on the Si substrate of the optical circuit including the modulator. The inspection circuit 63A of FIG. 12 corresponds to the Test Mod 21 which is part of the inspection circuit 20 of FIG. 3. FIG. 12 (b) illustrates cross-sectional structures (x-z plane) of the waveguides of the portion i of the inspection waveguide 60-1 and the portion ii of the inspection waveguide 60-2 among the four inspection waveguides corresponding to the arm waveguide 35a (waveguide A) of the main circuit.

Referring to FIG. 12 (a), the inspection circuit 63A has a configuration in which four inspection waveguides 60-1 to 60-4 are included in the loop path of the light reflection section illustrated in FIG. 10. The length of each of the four inspection waveguides 60-1 to 60-4 in the inspection circuit 63A is set to ¼ of the length of the arm waveguide 35a which is the modulation waveguide of the main circuit. The four inspection waveguides 60-1 to 60-4 have the same cross-sectional structure in terms of a PN junction structure. Thus, in the cross section of the x-z plane, the positional relationship between the P-type region and the N-type region is the same. Finally, the length of the four inspection waveguides 60-1 to 60-4 is not necessarily limited to ¼ of the length of the arm waveguide 35a.

The test light 40 is input from a bottommost rectangular waveguide 37 to an input port of the optical branch 38. The test light is equally split by the optical branch 38, and the branch light beams having the same intensity are output from the branch port in two directions of the loop path including the four inspection waveguides. One branch light beam output from one branch port of the optical branch 38 propagates in the y direction through the inspection waveguide 60-1, passes through the rectangular waveguide 39-1 and propagates in the reverse direction (−y direction) through the inspection waveguide 60-2. Further, the light beam passes through the rectangular waveguide 39-2, propagates through the inspection waveguide 60-3 in the y direction again, passes through the rectangular waveguide 39-3 and propagates through the inspection waveguide 60-4 in the reverse direction (−y direction). As described above, in the four inspection waveguides of the inspection circuit 63A, the adjacent inspection waveguides are connected in series by the rectangular waveguide, and the four inspection waveguides are connected in a loop shape between the branch-side ports of the optical branch so that the propagation direction of the test light alternately changes.

As described above, one of the branch light beams propagates clockwise in the loop path from the first branch port and reaches the second branch port. Similarly, the other of the branch light beams propagates counterclockwise in the loop path from the second branch port and reaches the first branch port. The two branch light beams propagated in the opposite directions to each other sequentially pass through the four inspection waveguides 60-1 to 60-4 and are lost over the entire lengths of the inspection waveguides 60-1 to 60-4.

In the optical branch 38, the two branch light beams propagated through the four inspection waveguides of the loop path are multiplexed in the same phase and output from the rectangular waveguide 37 as the test light having passed through the inspection waveguides 60-1 to 60-4.

FIG. 12 (b) illustrates cross-sectional structures of the waveguides sensed by the test light in the above-described four inspection waveguides 60-1 to 60-4. A left part of FIG. 12 (b) illustrates a case where the mask for the P-type region is displaced in the +x direction in the waveguide structure of the portion i sensed by the test light traveling through the inspection waveguide 60-1 in the y direction. In other words, only the P-type region 51 is displaced in the +x direction, and thus, P-type impurities are redundantly introduced to the N-type region side, and the overlapping region 54 is generated. A right part of FIG. 12 (b) illustrates a case where the mask for the P-type region is displaced in the +x direction in the waveguide structure of the portion ii sensed by the test light traveling in the inspection waveguide 60-2 in the −y direction. Also in the present embodiment, the waveguide structures sensed by the test light in the two inspection waveguides 60-1 and 60-2 are different only in that the positions of the P-type region and the N-type region are reversed left and right, and the profiles of the PN junctions caused by the mask displacement are substantially the same. The test light surrounding the loop path will sense a symmetrical cross-sectional structure with respect to the center line of the rib structure. The waveguide structures of the portion i and the portion ii sensed by the test light are the same in that the overlapping region 54 is formed beyond the center line of the rib structure only in the P-type region. The same applies to the remaining inspection waveguides 60-3 and 60-4, and in the four inspection waveguides 60-1 to 60-4, a loss of the waveguide caused by the mask displacement for the P-type region is also the same. Consistency of the cross-sectional structures sensed by the test light through the four inspection waveguides 60-1 to 60-4 is the same even if displacement occurs only in the mask of the N-type region or displacement occurs independently in both the P-type and N-type masks at the same time.

Also in the inspection circuit of the present embodiment, the optical branch 38 operates to propagate the two test light beams split to equal intensity to the inspection waveguide. As in a case of the second embodiment, the optical branch 38 propagates the two branch light beams to the inspection waveguide in opposite directions. It should be noted that, similar to the second embodiment, in a case of the third embodiment in which the four inspection waveguides 60-1 to 60-4 are included inside the loop path by the optical branch 38, the test light is propagating through the inspection waveguide simultaneously in two directions.

The total transmittance of the four inspection waveguides 60-1 to 60-4 in the inspection circuit 63A of the present embodiment coincides with the transmittance of the arm waveguide 35a of the main circuit. The transmittance (t_{A}, t_{B}) of each arm waveguide can be inspected by two inspection circuits corresponding to the two arm waveguides 35a and 35b of the main circuit. Similarly to the first and second embodiments, a loss of the MZI type modulator of the main circuit can be estimated only by substituting the electric field transmittance (t_{A}, t_{B}) obtained from the inspection circuit of the waveguide A and the inspection circuit of the waveguide B into the Expression (2). Also in the present embodiment, the arm waveguides 35a and 35b of the main circuit and the four inspection waveguides 60-1 to 60-4 of the inspection circuit are designed to be all parallel to each other so that there is no difference in the cross-sectional structure of the modulation waveguide between the inspection circuit 63A and the main circuit. Also in the inspection circuit 63A of FIG. 12, the inspection can be performed by using only test light without using an electric signal, which only requires a simplified measurement system including only one optical input/output fiber, so that the inspection procedure becomes simpler.

The inspection circuit 63A of FIG. 12 is seemingly similar to the zigzag-shaped inspection circuit in related art illustrated in FIG. 7. However, the inspection circuit 63A is different in that the four inspection waveguides have the same configuration as the configuration of the arm waveguide of the main circuit, and adjacent inspection waveguides are connected in series by rectangular waveguides such that the propagation direction of the test light alternately changes. The inspection circuit 63A is also different in that the four inspection waveguides are connected in a loop shape between branch-side ports of the optical branch.

It can be easily understood that the configuration in which the plurality of divided inspection waveguides is provided in the loop path of the optical branch in FIG. 12 can be further expanded. For example, if six inspection waveguides are alternately connected in series by rectangular waveguides, the length of each of the six inspection waveguides can be set to ⅙ of the length of the arm waveguide that is the modulation waveguide of the main circuit. If the eight inspection waveguides are alternately connected in series by the rectangular waveguides, each length of the eight inspection waveguides becomes ⅛ of the length of the arm waveguide that is the modulation waveguide of the main circuit. The length of the inspection circuit can be significantly shortened.

In the above-described three embodiments, in each inspection circuit, the effective length of the inspection waveguide is set to be the same as the length of each arm waveguide of the main circuit. The loss of the arm waveguide of the main circuit can be estimated by setting the length of the inspection waveguide to 1/N (or x times: 0<x<1) of the length of the arm waveguide of the main circuit and multiplying a loss of the waveguide to be measured by N/2 (or x/2) in order to further reduce a size of the inspection circuit in a waveguide length direction.

For example, in the inspection circuit 61A of the first embodiment, the length of the inspection waveguide 60a is set at ½ of the length of the arm waveguide 35a of the main circuit, but the length can be further made half, that is, ¼ without changing the configuration of the inspection circuit 61A. In this case, a loss obtained from the two inspection circuits of the waveguide A and the waveguide B is half, and thus, if this loss is doubled, the loss of the MZI of the main circuit can be estimated by Expression (2). As described above, the loss of the arm waveguide of the main circuit can be estimated by setting the length of the inspection waveguide to 1/N instead of ½ and multiplying the loss to be measured by the inspection circuit by N/2. In the manufacturing process of the optical circuit including the modulator, in order to grasp process change and variation, it may be sufficient to detect the change in a loss value. If the inspection waveguide is shortened as described above, estimation accuracy degrades, and thus, it is only necessary to select a degree of shortening (value of N) according to a quality level required in the manufacturing process.

It should be therefore noted that, in the first to the third embodiments, the length (½, ¼) of the inspection waveguide with respect to the length of the arm waveguide of the main circuit may be any length by the above-described shortening. In the inspection circuit in the optical circuit of the present disclosure, the phase shifters 34a and 34b of the rectangular waveguides provided in the inspection circuit in related art are unnecessary, and adjustment of the phase shifters is also unnecessary. Furthermore, the present invention excels in that the inspection system and the measurement procedure can be greatly simplified as compared with related art also in that a loss can be measured with one input/output fiber for one inspection circuit.

### INDUSTRIAL APPLICABILITY

The present invention can be used for optical communication.

1. An optical circuit formed on a silicon substrate, the optical circuit comprising:
a Mach-Zehnder interferometer type modulator including two arm waveguides in which a PN junction is formed in a cross section; and
an inspection circuit for the modulator, including:
an input section for receiving test light, the input section including a rectangular waveguide;
at least one inspection waveguide being connected to the rectangular waveguide, in parallel to the two arm waveguides, and having a PN junction having the same configuration as the PN junction of at least one of the arm waveguides; and
an optical branch for splitting the test light to two branch light beams having equal intensity and propagating the two branch light beams to the inspection waveguide, the optical branch including a rectangular waveguide.

2. The optical circuit according to claim 1,
wherein the input section is a single rectangular waveguide,
the at least one inspection waveguide comprises a single inspection waveguide having a ½ length of the arm waveguide,
one end of the single inspection waveguide is connected to the single rectangular waveguide of the input section, and
the other end of the single inspection waveguide is connected to an input-side port of the optical branch, and branch-side ports of the optical branch are connected in a loop shape by a rectangular waveguide.

3. The optical circuit according to claim 1,
wherein the input section is a single rectangular waveguide connected to the optical branch,
the at least one inspection waveguide comprises two inspection waveguides having a ½ length of the arm waveguide,
one end of each of the two inspection waveguides is connected to a branch-side port of the optical branch, and
the other end of each of the two inspection waveguides is connected by a rectangular waveguide, and the two inspection waveguides are connected in a loop shape between the branch-side ports.

4. The optical circuit according to claim 1,
wherein the input section is a single rectangular waveguide connected to the optical branch, and
the at least one inspection waveguide comprises four inspection waveguides having a ¼ length of the arm waveguide, and adjacent inspection waveguides of the four inspection waveguides are connected in series by a rectangular waveguide, so that a propagation direction of the test light alternately changes, and the four inspection waveguides are connected in a loop shape between branch-side ports of the optical branch.

5. The optical circuit according to claim 1, wherein the two arm waveguides are rib waveguides, and the rectangular waveguide is a ridge-type waveguide not including a PN junction.

6. The optical circuit according to claim 1, wherein a configuration of a PN junction in a cross section of a first arm waveguide of the two arm waveguides and a configuration of a PN junction in a cross section of a second arm waveguide are symmetric with respect to a center line of the two arm waveguides parallel to a light propagation direction, and the optical circuit includes a first inspection circuit corresponding to the first arm waveguide and a second inspection circuit corresponding to the second arm waveguide.

7. The optical circuit according to claim 1, wherein a configuration of a PN junction in a cross section of a first arm waveguide of the two arm waveguides and a configuration of a PN junction in a cross section of a second arm waveguide are the same, and the optical circuit includes a single inspection circuit common to the first arm waveguide and the second arm waveguide.
